(19) United States
(12) Patent Application Publication
(10) Pub. No.: US 2016/0149782 A1
(43) Pub. Date: May 26, 2016

(54) METHOD OF DETERMINING STATUS OF SERVING NODES

(71) Applicants: INVENTEC (PUDONG) TECHNOLOGY CORPORATION, SHANGHAI (CN); INVENTEC CORPORATION, TAIPEI CITY (TW)

(72) Inventor: Yu Liang SUN, Taipei City (TW)

(21) Appl. No.: 14/684,444

(22) Filed: Apr. 13, 2015

(30) Foreign Application Priority Data
Nov. 24, 2014 (CN) 201410680627.6

(51) Int. Cl. H04L 12/26; H04L 29/06

(52) U.S. Cl. CPC H04L 43/0805; H04L 69/16

(57) ABSTRACT

A method of determining the status of serving nodes suited for a parallel data computing architecture is disclosed herein. The method comprises the following steps: sending a first connection request from the first serving node to the second serving node through a first data communication interface; determining a first connection signal fed from the second serving node by the first serving node; sending a second connection request from the first serving node to the second serving node through a second data communication interface by the first serving node while the first connection signal shows that a connection between the serving nodes is unable to be built; determining the second connection signal fed from the second serving node by the first serving node so as to decide a status of the second serving node to process a status response procedure, thereby avoiding a huge amount time-consuming waiting.

### BACKGROUND OF THE INVENTION

1. Field of Invention

The present invention relates to a method of determining the status of serving nodes, and in particular to a parallel data computing architecture.

2. Description of Prior Art

Conventionally, parallel computing architecture for big data, such as Hadoop, the most common platform for parallel and scattering computing. Hadoop is a software framework, comprising a plurality of serving nodes (such as servers). During the process of data computing by parallel and distributed computing, each of the plurality of serving nodes needs to wait for the other serving nodes to determine whether the other serving nodes are timed out signals and have no response. Hence, a method to determine whether a plurality of connections among the plurality of serving nodes are timed out or a certain serving node has malfunctioned is needed.

FIG. 1 is a schematic drawing of a parallel data computing architecture 100 of a prior art. The parallel data computing architecture 100 comprises a first serving node 10 and a serving node 20. The first serving node 10 and the second serving node 20 connect with an Internet communication interface 15 (such as TCP/IP). The first serving node 10 and the second serving node 20 could be servers. Generally, every two serving nodes will set a number of retries (such as 2) and a preset waiting duration between every two retries. When the number of retries is reached without receiving a response, the first serving node 10 will receive a Timeout signal. However, a processor of the second serving node might be too busy to respond, so the preset waiting duration is usually set as several minutes. In a group of nodes for a large data computing architecture such as Hadoop, if only one of the serving nodes has malfunctioned, each of the other serving nodes needs to wait to reach the number of retries to determine whether the serving node has malfunctioned, which wastes a lot of time.

FIG. 2 is a schematic drawing of a parallel data computing architecture 200 of another prior art. The difference between FIG. 2 and FIG. 1 is that the parallel data computing architecture 200 additionally adds a switch 30 between the first serving node 10 and the second serving node 20. The switch 30 could be a common ARISTA internet switch which forms an indirect connection between the first serving node 10 and the second serving node 20. When one serving node (10 or 20) has malfunctioned, the switch 30 will transmit a reset signal corresponding to the internet communication interface of TCP/IP to the other serving nodes which are trying to connect to the malfunctioned serving node, then the other serving nodes don't need to wait to know a status of the malfunctioned serving node and connect the other serving nodes. The disadvantage is an additional switch 30 is needed, thereby adding additional costs.

### SUMMARY OF THE INVENTION

Hence, an objective of the present invention is to provide a method of determining the status of serving nodes, especially for a parallel data computing architecture (Hadoop), which does not waste too much time on determining whether each serving node has malfunctioned or not by only using TCP/IP interface. Furthermore, in the present invention, there is no need for adding an additional switch in the parallel data computing architecture, thereby reducing hardware costs.

To achieve the above objective, the present invention provides a method of determining the status of serving nodes, especially for a parallel data computing architecture. The architecture comprises a first serving node and a second serving node. The first serving node comprises a first processor and a first BMC (baseboard management controller). The second serving node comprises a second processor and a second BMC. The method comprises:

Sending a first connection request from the first serving node to the second serving node through a first data communication interface.

Determining a first connection signal fed back from the second serving node by the first serving node based on the first connection request.

Sending a second connection request from the first serving node to the second serving node through a second data communication interface by the first serving node while the first connection signal shows that a connection between the first serving node and the second serving node is unable to be built.

Determining the second connection signal fed back from the second serving node by the first serving node so as to decide a status of the second serving node to process a status response procedure.

In one preferred embodiment, the parallel data computing architecture is Hadoop.

In one preferred embodiment, the first data communication interface complies with TCP/IP (Transmission Control Protocol/Internet Protocol) protocol.

In one preferred embodiment, the step of determining a first connection signal fed back from the second serving node by the first serving node based on the first connection request further comprises:

Determining whether the first connection signal is a Timeout signal or not by the first serving node; the Timeout signal means a one-time connection between the first serving node and the second serving node is over a preset waiting duration.

In one preferred embodiment, the second communication interface complies with IPMI (intellectual platform management interface) protocol, the step of sending a second connection request from the first serving node to the second serving node through a second data communication interface by the first serving node further comprises:

Sending the second connection request from the first BMC of the first serving node to the second BMC of the second serving node through the second data communication interface to determine whether the second processor of the second serving node is running or not.

In one preferred embodiment, the step of determining the second connection signal fed back from the second serving node by the first serving node based on the second connection request further comprises:

Determining the second connection signal fed back from the second BMC of the second serving node through the second data communication interface by the first BMC of the first serving node. The second connection signal complies with IPMI protocol.

In one preferred embodiment, the step of determining the second connection signal fed back from the second serving node by the first serving node so as to decide a status of the second serving node to process a status response procedure further comprises:

Determining that the second serving node has malfunctioned, white the first serving node determines that the second connection signal means the connection between the first serving node and the second serving node is unable to be built and/or the second serving node is not running.

In one preferred embodiment, the status response procedure comprises:

Making the first serving node stop connecting with the second serving node.

In one preferred embodiment, the status response procedure comprises:

Making the first serving node connect with a third serving node of the parallel data computing architecture.

In one preferred embodiment, the step of determining the second connection signal fed back from the second serving node by the first serving node so as to decide a status of the second serving node to process a status response procedure further comprises:

Making the first serving node process a preset waiting procedure to reconnect with the second serving node, while the first serving node determines that the second connection signal means the second processor of the second serving node is under a high computing status (busy).

With comparison with the prior art, the present invention uses IPMI to access the BMC of every serving node, which is able to save a time-consuming waiting for confirming whether each serving node has malfunctioned or not by only using TCP/IP. In particular, while processing large data, a large amount of time could be saved. Meanwhile, there is no need to dispose any switch in the present invention, so hardware costs are reduced.

To allow the present invention to be more clearly understood, preferred embodiments are given below, and accompanied with drawings, and are described in detail as follows:

### BRIEF DESCRIPTION OF THE DRAWINGS

FIG. 1 is a schematic drawing of a parallel data computing architecture of a prior art.

FIG. 2 is a schematic drawing of a parallel data computing architecture of another prior art.

FIG. 3 is a schematic drawing of a parallel data computing architecture of a preferred embodiment of the present invention.

FIG. 4 is a flow chart of a method of determining the status of serving nodes of the first preferred embodiment of the present invention.

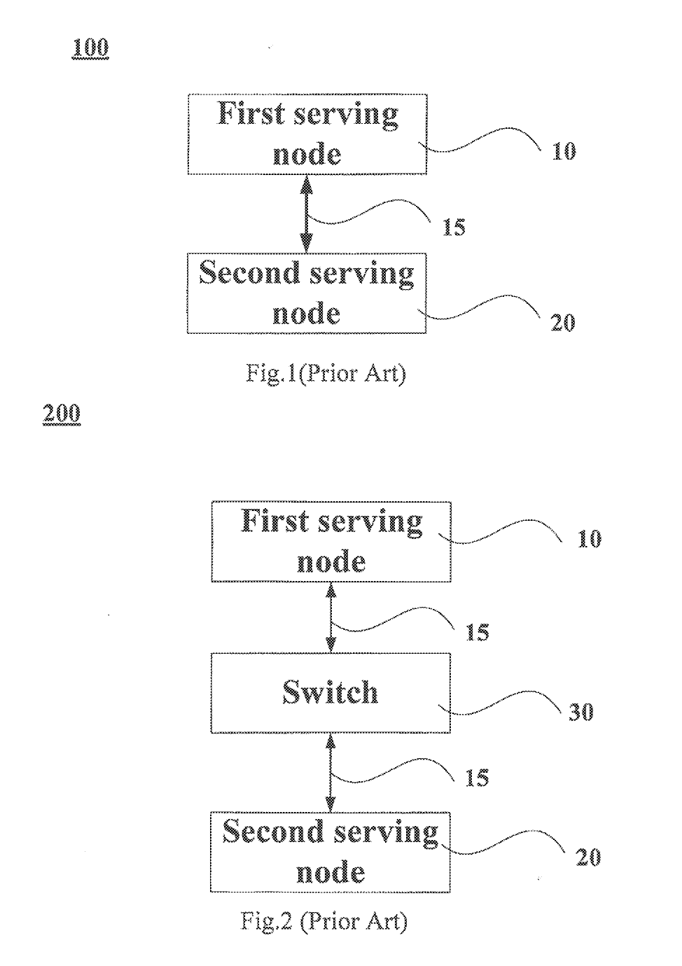

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention.

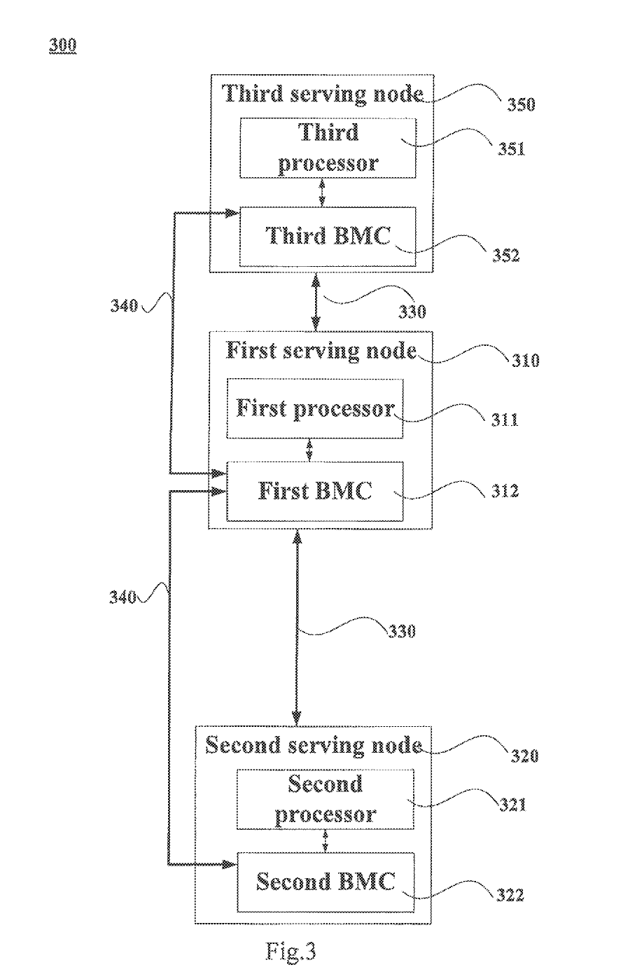

FIG. 3 is a schematic drawing of a parallel data computing architecture 300 of a preferred embodiment of the present invention. The architecture 300 comprises a first serving node 310 and a second serving node 320. The first serving node 310 comprises a first processor 311 and a first BMC 312. The second serving node 320 comprises a second processor 321 and a second BMC 322. Based on the parallel data computing architecture 300 of the present invention, at first, the first serving node 310 and the second serving node 320 transmit/receive data by a first data communication interface 330. Generally, the first data communication interface 330 is TCP/IP communication interface or other existing interact communication interfaces. In the preferred embodiment, with TCP/IP communication interface, every two serving nodes 310, 320 only make a one-time connection, the one-time connection comprises a preset waiting time (for example, if the preset waiting interval is 3 minutes, since there is a one-time waiting interval, the total waiting interval is 3 minutes) to determining whether the one-time connection is timed out or not. On the contrary, in the prior art, every two serving nodes need to reach a maximum number of re-connections (for example, 2 times) and an preset waiting interval for every two connections (for example, if the preset waiting interval is 3 minutes, with 2 waiting interval, the total waiting interval is 6 minutes) to determine the status of the serving node.

Then, a first connection signal fed back from the second serving node 320 to the first serving node 310 through the first data communication interface 330 based on the first connection request is used to determine whether a connection between the first serving node 310 and the second serving node 320 is built successfully. Furthermore, the first serving node 310 determines whether the first connection signal is a Timeout signal or not, the Timeout signal used to present the one-time connection between the first serving node 310 and the second serving node 320 is over a preset waiting interval (for example, 3 minutes of the preset waiting interval).

Further referring FIG. 3, when the first serving node 310 determines the first connection signal to know that the connection between the first serving node 310 and the second serving node 320 is unable to be built, the first serving node 310 accesses the second serving node 320 by a second data communication interface 340, then the first serving node 310 determines a second connection signal fed back from the second serving node 320 based on the second connection request by the second data communication interface 340, making the first serving node 310 determine the status of the second serving node 320. The first serving node 310 will process a corresponding procedure according to the status of the second serving node 320. In the preferred embodiment, the second communication interface 340 complies with IPMI protocol while the first serving node 310 accesses the second serving node 320 by the second data communication interface 340. In other words, the first BMC 311 of the first serving node 310 accesses the second BMC 321 of the second serving node 320 by the second data communication interface 340 to determine whether the second processor 322 of the second serving node 320 is running or not, and makes the second BMC 321 of the second serving node 320 respond the second connection signal comply with IPMI protocol, and makes the first BMC 311 of the first serving node 310 determine the status (malfunctioning or busy) of the second processor 322 of the second serving node 320 according to the second connection signal.

In the preferred embodiment, while the first serving node 310 judges the second connection signal fed back from the second serving node 320 to determine the connection between the first serving node 310 and the second serving node 320 has failed or the second serving node 320 is not running, the second processor 322 of the second serving node 320 is under a malfunctioning status to process a status response procedure. The status response procedure comprises: making the first serving node 310 stop the second serving node 320, and making the first serving node 310 connect a third serving node 350 of the parallel data computing architecture 300. A process of the first serving node 310 accessing the third serving node 350 is the same as the process of the first serving node 310 accessing the second serving node 320, and the third serving node 350 also comprises a third processor 351 and a third processor 352, and it is not repeated herein.

In another preferred embodiment, the step of using the first serving node 310 to determine the second connection signal fed back from the second serving node 320 based on the second connection request, then determining the status of the second serving node 320 to process the status response procedure further comprises: making the first serving node 310 process a preset waiting procedure to reconnect with the second serving node 320, while the first serving node 310 determines that the second connection signal means that the second processor of the second serving node 320 is under a high computing status (busy).

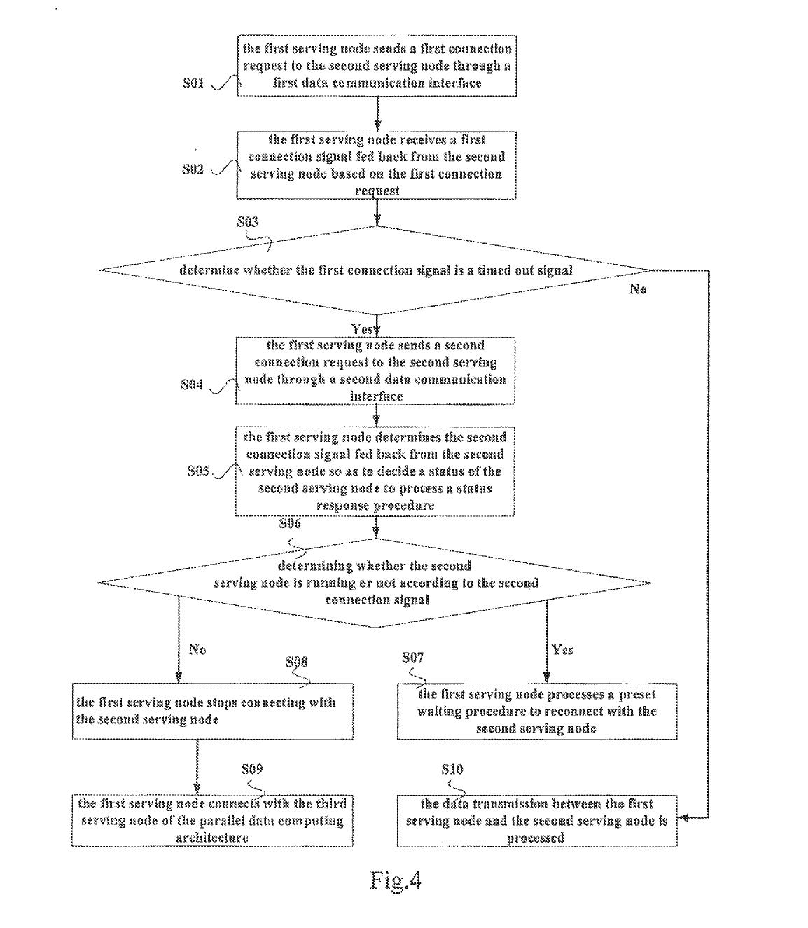

FIG. 4 is a flow chart of a method of determining the status of serving nodes of the first preferred embodiment of the present invention. The method is applied in the parallel data computing architecture 300 and the composing components thereof, which comprises:

Step S01, the first serving node 310 sends a first connection request to the second serving node 320 through a first data communication interface 330.

Step S02, the first serving node 310 receives a first connection signal fed back from the second serving node 320 based on the first connection request.

Step S03, the first serving node 310 determines the second connection signal fed back from the second serving node 320 based on the second connection request, to determine whether the first connection signal is a timed out signal (the determining method is mentioned above). If not, step SW, the data transmission between the first serving node 310 and the second serving node 320 is processed.

If yes, while the first connection signal shows that a connection between the first serving node 310 and the second serving node 320 is unable to be built, then step S04, the first serving node 310 sends a second connection request to the second serving node 320 through a second data communication interface 340. The second data communication interface 340 complies with IPMI protocol. In step S04, the first BMC 312 of the first serving node 310 sends the second connection request to the second BMC 322 of the second serving node 320 through the second data communication interface 340 to determine whether the second processor 321 of the second serving node 320 is running or not.

Step S05, the first serving node 310 determines the second connection signal fed back from the second serving node 320 so as to decide a status of the second serving node 320 to process a status response procedure. The first BMC 312 of the first serving node 310 is used to determine the second connection signal, which complies with IPMI protocol and is fed back from the second BMC 322 of the second serving node 320 by the second data communication interface 340.

Step S06, determining whether the second serving node 320 is running or not according to the second connection signal. If yes, in other words, while the first serving node 310 determines that the second connection signal means the second processor 321 of the second serving node 320 is under a high computing status (busy), determining that the second serving node 320 is busy. Then, step S07, the first serving node 310 processes a preset waiting procedure to reconnect with the second serving node 320.

If no, in other words, while the first serving node 310 determines that the second connection signal means that the connection between the first serving node 310 and the second serving node 320 is unable to be built and/or the second serving node 320 is not running, determining that the second serving node 320 is under a malfunctioning status, and to process the status response procedure. Then, step S08, the first serving node 310 stops connecting with the second serving node 320. Then, step S09, the first serving node 310 connects with the third serving node 350 of the parallel data computing architecture.

As mentioned above, the problem is solved by the method of determining the status of serving node suited for a parallel data computing architecture of the present invention. Meanwhile, the cost of hardware is reduced by eliminating the switch.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A method of determining the status of serving nodes, for a parallel data computing architecture comprising a first serving node and a second serving node, wherein the first serving node comprises a first processor and a first BMC (baseboard management controller), and the second serving node comprises a second processor and a second BMC, the method comprising the steps:
sending a first connection request from the first serving node to the second serving node through a first data communication interface;
determining a first connection signal fed back from the second serving node by the first serving node based on the first connection request;
sending a second connection request from the first serving node to the second serving node through a second data communication interface by the first serving node while the first connection signal shows that a connection between the first serving node and the second serving node is unable to be built; and
determining the second connection signal fed back from the second serving node by the first serving node based on the second connection request so as to decide a status of the second serving node to process a status response procedure.

2. The method according to claim 1, wherein the parallel data computing architecture is Hadoop framework.

3. The method according to claim 1, wherein the first data communication interface complies with TCP/IP (Transmission Control Protocol/Internet Protocol) protocol.

4. The method according to claim 3, wherein the step of determining a first connection signal fed back from the second serving node by the first serving node based on the first connection request further comprises a step of:
determining whether the first connection signal is a Timeout signal or not by the first serving node, wherein the Timeout signal means that a one-time connection between the first serving node and the second serving node is over a preset waiting duration.

5. The method according to claim 1, wherein the second communication interface complies with IPMI (intellectual platform management interface) protocol, the step of sending a second connection request from the first serving node to the second serving node through a second data communication interface by the first serving node further comprises:
sending the second connection request from the first BMC of the first serving node to the second BMC of the second serving node through the second data communication interface to determine whether the second processor of the second serving node is running or not.

6. The method according to claim 5, wherein the step of determining the second connection signal fed hack from the second serving node by the first serving node based on the second connection request further comprises:
determining the second connection signal fed back from the second BMC of the second serving node through the second data communication interface by the first BMC of the first serving node, wherein the second connection signal complies with IPMI protocol.

7. The method according to claim 1, wherein the step of determining the second connection signal fed back from the second serving node by the first serving node so as to decide a status of the second serving node to process a status response procedure further comprises:
determining that the second serving node is malfunctioning, while the first serving node determines that the second connection signal means the connection between the first serving node and the second serving node is unable to be built and/or the second serving node is not running.

8. The method according to claim 7, wherein the status response procedure comprises:
making the first serving node stop connecting with the second serving node.

9. The method according to claim 7, wherein the status response procedure comprises:
making the first serving node connect with a third serving node of the parallel data computing architecture.

10. The method according to claim 1, wherein the step of determining the second connection signal fed back from the second serving node by the first serving node so as to decide a status of the second serving node to process a status response procedure further comprises:
making the first serving node to process a preset waiting procedure to reconnect with the second serving node, while the first serving node determines that the second connection signal means that the second processor of the second serving node is under a high computing status.

11. A method of determining the status of serving nodes, for a parallel data computing architecture comprising a first serving node and a second serving node, wherein the first serving node comprises a first processor and a first BMC (baseboard management controller), and the second serving node comprises a second processor and a second BMC, wherein the parallel data computing architecture is Hadoop framework, the method comprising the steps of:
sending a first connection request from the first serving node to the second serving node through a first data communication interface;
determining a first connection signal fed back from the second serving node by the first serving node based on the first connection request;
sending a second connection request from the first serving node to the second serving node through a second data communication interface by the first serving node while the first connection signal shows that a connection between the first serving node and the second serving node is unable to be built; and
determining the second connection signal fed back from the second serving node by the first serving node based on the second connection request so as to decide a status of the second serving node to process a status response procedure.

12. The method according to claim 11, wherein the first data communication interface complies with TCP/IP (Transmission Control Protocol/Internet Protocol) protocol.

13. The method according to claim 12, wherein the step of determining a first connection signal fed back from the second serving node by the first serving node based on the first connection request further comprises a step of:
determining whether the first connection signal is a Timeout signal or not by the first serving node, wherein the Timeout signal means that a one-time connection between the first serving node and the second serving node is over a preset waiting duration.

14. The method according to claim 11, wherein the second communication interface complies with IPMI (intellectual platform management interface) protocol, the step of sending a second connection request from the first serving node to the second serving node through a second data communication interface by the first serving node further comprises:
sending the second connection request from the first BMC of the first serving node to the second BMC of the second serving node through the second data communication interface to determine whether the second processor of the second serving node is running or not.

15. The method according to claim 14, wherein the step of determining the second connection signal fed back from the second serving node by the first serving node based on the second connection request further comprises:
determining the second connection signal fed back from the second BMC of the second serving node through the second data communication interface by the first BMC of the first serving node, wherein the second connection signal complies with IPMI protocol.

16. The method according to claim 11, wherein the step of determining the second connection signal fed back from the second serving node by the first serving node so as to decide a status of the second serving node to process a status response procedure further comprises:
determining that the second serving node is malfunctioning, while the first serving node determines that the second connection signal means the connection between the rust serving node and the second serving node is unable to be built and/or the second serving node is not running.

17. The method according to claim 16, wherein the status response procedure comprises:
making the first serving node stop connecting with the second serving node.

18. The method according to claim 16, wherein the status response procedure comprises:
making the first serving node connect with a third serving node of the parallel data computing architecture.

19. The method according to claim 11, wherein the step of determining the second connection signal fed back from the second serving node by the first serving node so as to decide a status of the second serving node to process a status response procedure further comprises:
making the first serving node to process a preset waiting procedure to reconnect with the second serving node, while the first serving node determines that the second connection signal means that the second processor of the second serving node is under a high computing status.
